(19) United States
(12) Patent Application Publication
(10) Pub. No.: US 2026/0033689 A1
(43) Pub. Date: Feb. 5, 2026

(54) POWDER FEED DEVICE

(71) Applicant: SINTOKOGIO, LTD., Nagoya-shi (JP)

(72) Inventors: Atsushi HATA, Aichi (JP); Hiroyuki AMANO, Aichi (JP); Shintaro NISHIKAWA, Aichi (JP); Masanori UCHIDA, Aichi (JP); Yoshihiko OGI, Aichi (JP)

(73) Assignee: SINTOKOGIO, LTD., Nagoya-shi (JP)

(21) Appl. No.: 19/280,688

(22) Filed: Jul. 25, 2025

(30) Foreign Application Priority Data
Jul. 31, 2024 (JP) 2024-124499
Oct. 31, 2024 (JP) 2024-191961

(51) Int. Cl. A47L 9/28; G05D 7/06

(52) U.S. Cl. CPC A47L 9/2889; A47L 9/2805; A47L 9/2836; G05D 7/0676

(57) ABSTRACT

A powder feed device includes a storage portion configured to store powder, a feed duct connected to the storage portion, a flexible nozzle disposed in the storage portion, configured to inject air into the storage portion, and configured to allow the air and the powder to supplied from the feed duct, a measuring unit configured to measure a weight of the storage portion, and a control unit configured to control an injection time of the air injected by the nozzle based on the weight measured by the measuring unit.

### CROSS-REFERENCE TO RELATED APPLICATION

This application is based on Japanese Patent Application No. 2024-124499 filed with Japan Patent Office on Jul. 31, 2024, and Japanese Patent Application No. 2024-191961 filed with Japan Patent Office on Oct. 31, 2024, the entire contents of which are hereby incorporated by reference.

### TECHNICAL FIELD

The present disclosure relates to a powder feed device.

### BACKGROUND

Japanese Patent Application Laid-Open No. 2008-100212 discloses a device for feeding powder to a dust collector. This device includes a hopper for storing powder, a feed duct for feeding the powder in the hopper to the dust collector, and a nozzle disposed in the hopper that is flexible and configured to inject air into the hopper. The tip of the nozzle is a free end; as a result of the reaction force during injection, the nozzle moves around inside the hopper, stirs the inside of the hopper, and causes the powder to become airborne. The airborne powder is fed along with air from the feed duct to the dust collector. The powder fed to the dust collector is mixed with dust, thereby reducing the ignitability of the dust. The nozzle is controlled so that air is injected for a fixed period of time at fixed intervals.

### SUMMARY

In the device described in Japanese Patent Application Laid-Open No. 2008-100212, the distance between the upper surface of the powder stored in the hopper and the nozzle changes according to the amount of powder in the hopper. Therefore, in the device described in Japanese Patent Application Laid-Open No. 2008-100212, the amount of airborne powder changes depending on the amount of powder in storage. Because the supply amount of powder changes according to how much powder is stored in the hopper, there is a risk in the device described in Japanese Patent Application Laid-Open No. 2008-100212 that a constant (fixed) amount of powder cannot be fed to the dust collector. The present disclosure provides a technique enabling control so that a predetermined amount of powder is fed.

According to one aspect of the present disclosure, a powder feed device includes a storage portion configured to store powder, a feed duct connected to the storage portion, a flexible nozzle disposed in the storage portion, configured to inject air into the storage portion, and configured to allow the air and the powder to be fed from the feed duct, a measuring unit configured to measure a weight of the storage portion, and a control unit configured to control an injection time of the air injected by the nozzle based on the weight measured by the measuring unit.

According to the present disclosure, it is possible to control so as to feed a predetermined amount of powder.

### BRIEF DESCRIPTION OF DRAWINGS

FIG. 1 is a schematic diagram illustrating an example of a dust collection system provided with a powder feed device according to one embodiment.

FIG. 2A is a time chart illustrating relationships among control time of a solenoid valve, powder weight, and feed amount when the injection time is controlled at a fixed length of time.

FIG. 2B is a time chart illustrating relationships among control time of a solenoid valve, powder weight, and feed amount when the injection time is varied.

FIG. 3 is a time chart illustrating relationships among control time of the solenoid valve, measured weight by a load cell, and sampling weight.

FIG. 4 is a flowchart illustrating a powder feed method.

FIG. 5A is a graph showing transitions over time of powder weight and feed rate in an example.

FIG. 5B is a graph showing transitions over time of powder weight and feed rate in a comparative example.

FIG. 6 is a schematic diagram illustrating an example of a dust collection system provided with a powder feed device according to another embodiment.

FIG. 7 is a schematic diagram showing an end face of an ejector.

FIG. 8 is a time chart illustrating relationships among control time of solenoid valves, measured weight by a load cell, and sampling weight in the powder feed device according to another embodiment.

FIG. 9 is a schematic diagram illustrating an example of a dust collection system provided with a powder feed device according to yet another embodiment.

### DETAILED DESCRIPTION

Hereinafter, embodiments of the present disclosure will be described in detail with reference to the drawings. In the description of the drawings, the same reference numerals are assigned to the same or equivalent elements, and redundant description is omitted. Dimensional ratios shown in the drawings do not necessarily match those in the specification. The terms “upper,” “lower,” “left,” and “right” are based on the illustrated state for convenience.

### [Configuration of Powder Feed Device]

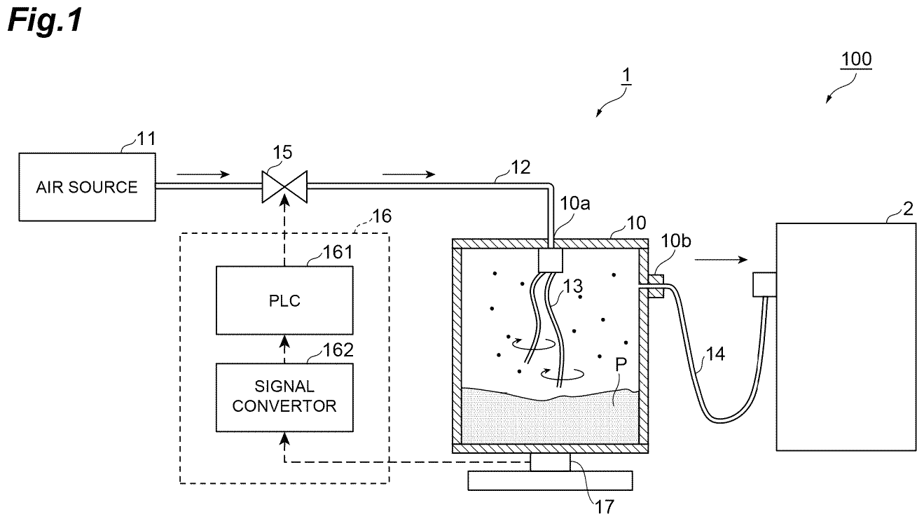

FIG. 1 is a schematic diagram illustrating an example of a dust collection system provided with a powder feed device 1 according to one embodiment. As shown in FIG. 1, the dust collection system 100 includes the powder feed device 1 and a dust collector 2. The powder feed device 1 is applied, for example, to the dust collector 2 installed in a factory or similar setting. The dust collector 2 traps dust (particulate matter in air) using a filter. Dust is a fine powder able to float in air, including fumes generated by laser processing, plasma processing, and welding. Because a filter can become charged when charged dust adheres to it or when friction occurs as dust contacts the filter, static electricity can be generated, which in turn can lead to ignition. Thus, by feeding an inert powder to the dust collector 2 and mixing that inert powder with the dust, the powder feed device 1 reduces the ignitability.

The powder feed device 1 includes a hopper 10 (an example of a storage portion), which is an example of a portion configured to store powder. The hopper 10 stores a powder P. The powder P is, for example, an inert powder. As one specific example, the powder P is a powder of calcium carbonate or calcium hydroxide. The hopper 10 has an inlet port 10a for compressed air and an outlet port 10b. An air source 11 is connected to the compressed air inlet port 10a via a pipe 12. Thus, compressed air from the air source 11 is fed to the interior of the hopper 10 via the pipe 12.

The powder feed device 1 has a nozzle 13 disposed inside the hopper 10. The nozzle 13 is a tubular member, is flexible, and may be formed of, for example, nylon, polyurethane, silicone, or the like. The rear end of the nozzle 13 is connected to the inlet port 10a for compressed air, and receives compressed air. The tip of the nozzle 13 is a free end, injecting compressed air into the hopper 10. At that time, the nozzle 13 moves irregularly inside the hopper 10 (so-called “thrashing” action) under the reaction force of the injection, stirring the interior of the hopper 10. As a result, the deposited powder P becomes airborne. Because the nozzle 13 is flexible, even powder gathering in corners of the hopper 10 can be lifted into the air. The airborne powder P is discharged along with air from the outlet port 10b of the hopper 10.

The powder feed device 1 includes a feed duct 14 connected to the hopper 10. The terminal end of the feed duct 14 is connected to the outlet port 10b of the hopper 10, and the leading end is connected to the dust collector 2. The powder P stored in the hopper 10 is fed to the dust collector 2 through the feed duct 14.

A solenoid valve 15 is provided in the pipe 12. The solenoid valve 15 is opened and closed under the control of a control unit 16, thereby changing the feed amount and timing of the compressed air. The control unit 16 includes a PLC (Programmable Logic Controller) 161 and a signal converter 162. The PLC is an apparatus that includes a processor, memory, display, and input/output unit. The signal converter 162 is a device that converts sensor output and other signals into electrical signals.

The control unit 16 controls the injection time of the air injected by the nozzle 13 based on the weight of the hopper 10. The hopper 10 is supported via load cell 17 (an example of a measuring unit). The load cell 17 outputs to the control unit 16 a sensor signal related to the weight of the hopper 10. In the control unit 16, the signal converter 162 converts the sensor signal from the load cell 17 into a voltage signal or the like. The PLC 161 acquires the weight of the hopper 10 based on the voltage signal. The PLC 161 controls the opening/closing timing and opening/closing duration of the solenoid valve 15 in accordance with the measured weight of the hopper 10.

### [Details of Operation of the Control Unit]

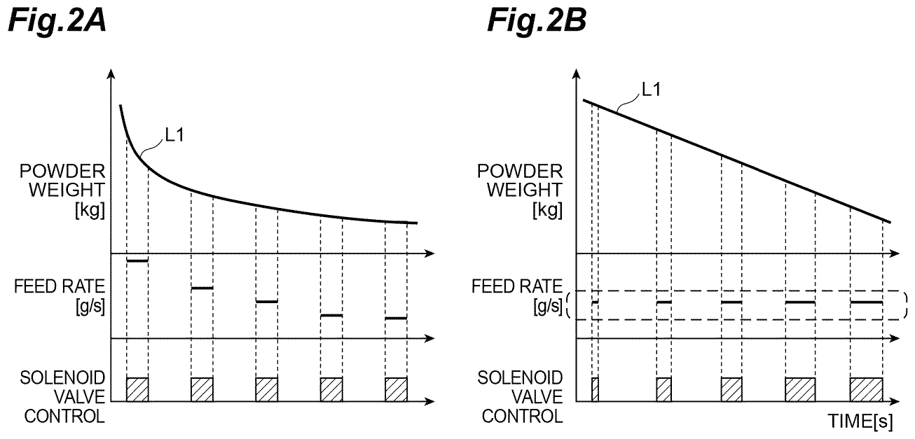

FIG. 2A is a time chart illustrating relationships among control time of the solenoid valve, powder weight, and feed amount when the injection time is controlled at a fixed duration. FIG. 2B is a time chart illustrating relationships among control time of the solenoid valve, powder weight, and feed amount when the injection time is varied.

As shown in FIG. 2A, if the control unit 16 controls the injection time of the solenoid valve 15 to be a fixed duration at constant intervals, the powder P is fed as time passes, so the weight of the powder decreases (curve L1 in the figure). When the amount of stored powder P in the storage portion decreases, the distance between the upper surface of the stored powder P and the nozzle becomes greater, and the amount of airborne powder decreases. As a result, the feed amount (hereafter also referred to as the feed rate) per unit time decreases over time, so there is a possibility that a predetermined amount of the powder P can no longer be fed to the dust collector 2.

For this reason, through controlling the injection time of the nozzle 13, the control unit 16 implements a metered feed of the powder P. A metered feed of the powder P means that the amount of powder P fed per unit time is constant—in other words, that the feed rate of the powder P remains constant. As shown in FIG. 2B, the control unit 16 sets a short injection time when the weight of the powder P is high, and gradually lengthens the injection time as the weight of the powder P decreases (straight line L1 in the figure). Consequently, a metered feed of the powder P can be achieved as indicated by the dashed outline in the figure.

The control unit 16 may calculate the feed rate of the powder P based on the weight of the powder P before and after injection, as well as the injection time, and may control the next injection time by comparing the calculated feed rate with a target feed rate. The target feed rate is a preset value determined by an operator or the like. The control unit 16 stores in memory the measurement results of the load cell 17 over time. The control unit 16 also stores in memory along with time the injection time-namely, the opening/closing time of the solenoid valve 15. Thus, the control unit 16 can use the weight of the powder P before and after injection and the injection time for calculation, and can compute the feed rate. The control unit 16 then determines the injection time so that the calculated feed rate approaches the target feed rate.

When the measured feed rate exceeds the target feed rate, the control unit 16 may set the injection time for the next injection to be a predetermined amount shorter than the current injection time. The predetermined amount of time is set as appropriate. When the measured feed rate is at or below the target feed rate, the control unit 16 may set the injection time for the next injection to be a predetermined amount longer than the current injection time. The predetermined amount of time is set as appropriate. When the measured feed rate falls within a predetermined range that encompasses the target feed rate, the control unit 16 may set the next injection time to be the same as the current injection time without change. The predetermined range is a suitably set feed rate range. By setting that predetermined range, the control unit 16 can perform control so that the feed rate converges more readily to the target feed rate.

The control unit 16 may display on a display the determined injection time, the calculated feed rate, and the like, allowing an operator to confirm that the powder feed device 1 is feeding the powder P at a predetermined amount.

Because the powder P is light in weight, the weight change of the hopper 10 per injection may be small enough to be below the detection limit of the load cell 17. Thus, the control unit 16 may measure the weight of the hopper 10 in the cycle during which multiple injections are performed. Furthermore, since the nozzle 13 moves around under recoil when the powder P is injected, noise may be present in the measurement result of the load cell 17. Therefore, the control unit 16 may stop injection of air by the nozzle 13 while the load cell 17 measures the weight of the hopper 10. “While the load cell 17 measures the weight of the hopper 10” refers to the period during which data are being sampled as the measuring time for the load cell 17.

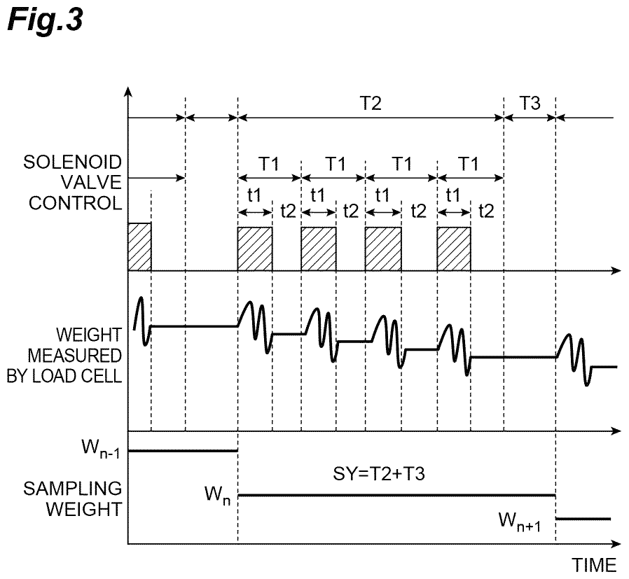

FIG. 3 is a time chart illustrating relationships among the control time of the solenoid valve, the weight measured by the measuring unit (load cell), and the sampling weight. As shown in FIG. 3, the control unit 16 may execute multiple injections at the determined injection time. In the example shown in FIG. 3, a total of four injections are executed within each cycle T1. The cycle T1 includes an injection period t1 and a stop period t2. During the injection period t1, the nozzle 13 moves around, thus introducing noise in the measurements made by load cell 17. During the stop period t2, because the nozzle 13 is halted, noise is not introduced in the measurements made by load cell 17. Hence, the control unit 16 samples the data output in the stop period t2, and by averaging or similar processing of the sampled data, calculates the weight measured over the measurement cycle T2, which in turn includes four of the cycles T1. The sampling weight Wₙ is determined for each measurement cycle SY, which includes the measurement cycle T2 plus the computation time T3. For example, in the previous measurement cycle, the sampling weight was Wₙ₋₁, and in the next measurement cycle, the sampling weight will be Wₙ₊₁. By performing the calculation as shown in FIG. 3, the control unit 16 can capture changes in the weight of the powder P appropriately while reducing noise caused by the nozzle 13.

### [Operation of the Powder Feed Device (Powder Feed Method)]

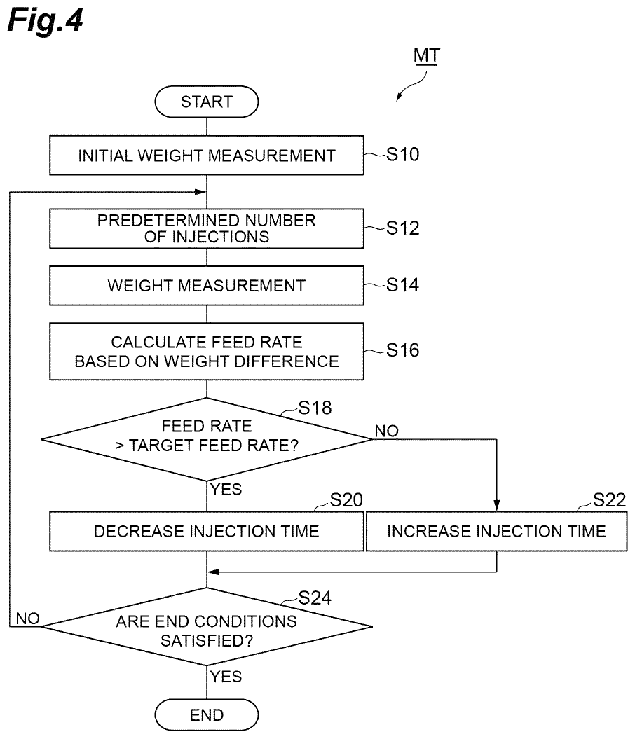

FIG. 4 is a flowchart illustrating the powder feed method. The flowchart shown in FIG. 4 starts under the control of the control unit 16 when the hopper 10 is filled with the powder P and an operation command is issued by an operator.

At Step S10, the control unit 16 measures the initial weight of the hopper 10. The control unit 16 measures the weight of the hopper 10 based on signals from the load cell 17. Then, at Step S12, the control unit 16 opens the solenoid valve 15 for a prescribed number of times and for a prescribed duration. As a result, compressed air is blown into the hopper 10, and the compressed air and the powder P are delivered from the hopper 10 to the dust collector 2.

Next, at Step S14, the control unit 16 measures the weight of the hopper 10. The control unit 16 measures the weight of the hopper 10 based on signals from the load cell 17. Then, at Step S16, the control unit 16 calculates the difference (weight difference) between the initial weight measured at Step S10 and the weight measured at Step S14. The control unit 16 computes the feed rate based on the absolute value of that weight difference. As one specific example, the control unit 16 may compute the feed rate by dividing the weight difference by the feed time.

Next, at Step S18, the control unit 16 determines whether the feed rate calculated at Step S16 is greater than the target feed rate. When the control unit 16 determines that the calculated feed rate is greater than the target feed rate (Step S18: YES), then at Step S20, it reduces the next injection time. When the calculated feed rate is not determined to be greater than the target feed rate (Step S18: NO), the control unit 16 proceeds to Step S22 and increases the next injection time.

After completion of either Step S20 or Step S22, the control unit 16 determines whether the end condition is satisfied. The end condition, set in advance by an operator or the like, is a condition for stopping powder feed. For example, the end condition may be that an end command is received from an operator, that a specified time has been reached, or that the dust collector 2 has stopped. When it is determined that the end condition is not satisfied (Step S24: NO), the process returns to Step S12 and repeats Steps S12 through S24. When it is determined that the end condition is satisfied (Step S24: YES), the flowchart shown in FIG. 4 finishes.

### Summary of Embodiments

In the powder feed device 1, the powder P in the hopper 10 becomes airborne through the flexible nozzle 13 disposed in the hopper 10, and is fed with air from the feed duct 14 to the dust collector 2. The weight of the hopper 10 is measured by the load cell 17. Based on the measured weight, the injection time of the air injected by the nozzle 13 is controlled. Because the powder feed device 1 is capable of controlling the injection time of the air according to the weight of the hopper 10, it can be controlled so as to feed a predetermined amount of the powder P to the dust collector 2.

### Variation Example

While various exemplary embodiments have been described above, the present invention is not limited to those exemplary embodiments; various omissions, substitutions, and changes may be made.

For example, in the above embodiment, the powder feed device 1 is described as having two nozzles, but it may have a single nozzle or three or more nozzles. The nozzle may also be branched partway along its length, so that the number of tips is larger than the number of ends at the rear.

The control unit 16 is not limited to a PLC and a signal converter as long as it can perform arithmetic processing on sensor outputs and control the injection time of the nozzle 13. For example, the control unit 16 may be configured as a computer system including a CPU (Central Processing Unit), RAM (Random Access Memory) and ROM (Read Only Memory) or similar memory, input/output devices such as a touch panel, mouse, keyboard, and display, as well as a communication device such as a network card. The control unit 16 may also control the flow rate and pressure of the air injected by the nozzle 13.

In the embodiment described above, the weight of the hopper 10 is measured by the load cell 17 (load cell) as an example; however, the hopper 10 may be supported by an elastic body (another example of a measuring unit), such as a spring, so that the weight is measured thereby. Alternatively, the weight of the powder may be measured directly by a sensor (another example of a measuring unit), such as an image sensor disposed in the hopper 10, with the weight of the empty hopper 10 added to obtain the total weight of the hopper 10. In other words, “measuring the weight of the hopper 10” includes directly measuring the weight of the powder.

The powder feed device 1 may also be applied to a duct that carries dust-laden air—for instance, in a factory. In such a case, the powder feed device 1 is connected to the duct instead of the dust collector 2. Because dust accumulations in the duct can lead to ignition caused by static electricity, the powder feed device 1 supplies inert powder into the duct and reduces ignitability by mixing the inert powder with dust.

### [Evaluation of Feed Rate]

Below, an example performed for evaluating the feed rate using the powder feed device 1 is described. The present disclosure is not limited to these embodiments.

### Example

Using the powder feed device 1, the powder P was fed into the dust collector 2. As shown in FIG. 3, by sampling in this manner, measurement accuracy for the weight of the hopper 10 was improved, and as shown in FIG. 2B, constant-volume control was carried out. The conditions were as follows:
Powder P: calcium carbonate powder
Cycle T1: 30 seconds
Measurement cycle SY: 180 seconds
Target feed rate TP: 0.1 g/s

### Comparative Example

Using the powder feed device 1, the powder P was introduced into the dust collector 2. As shown in FIG. 3, sampling was performed to improve measurement accuracy for the weight of the hopper 10, but as shown in FIG. 2A, the injection time was set to a predetermined time. All other conditions were the same as in the example.

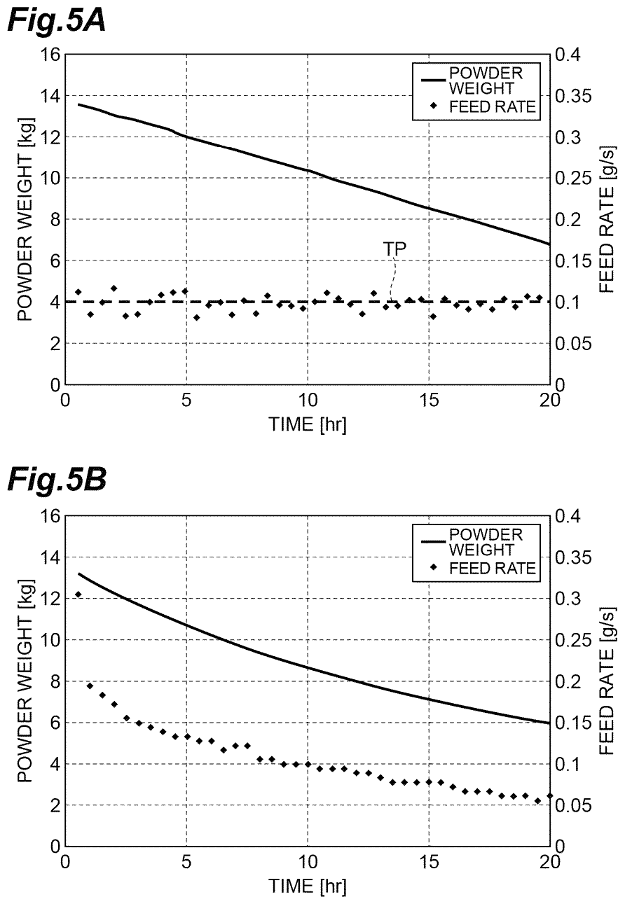

FIG. 5A is a graph illustrating the change over time of the powder weight and the feed rate in the example, and FIG. 5B is a graph illustrating the change over time of the powder weight and the feed rate in the comparative example. As shown in FIGS. 5A and 5B, in both the example and the comparative example, the powder weight decreases over time, dropping by about 6 kg from startup of the device until 20 hours have passed. Furthermore, as shown in FIG. 5A, in the powder feed device of the example, the feed rate of the powder P was confirmed to remain close to the target feed rate TP from device startup until 20 hours had passed. By contrast, in the powder feed device of the comparative example, the feed rate was two to three times the target feed rate TP for several hours after device startup, and the feed rate exceeded the target feed rate TP from startup until ten hours had passed, while from ten hours to twenty hours it was below the target feed rate TP. Thus, it was confirmed that the powder feed device 1 of the example can be controlled to feed a predetermined amount of powder.

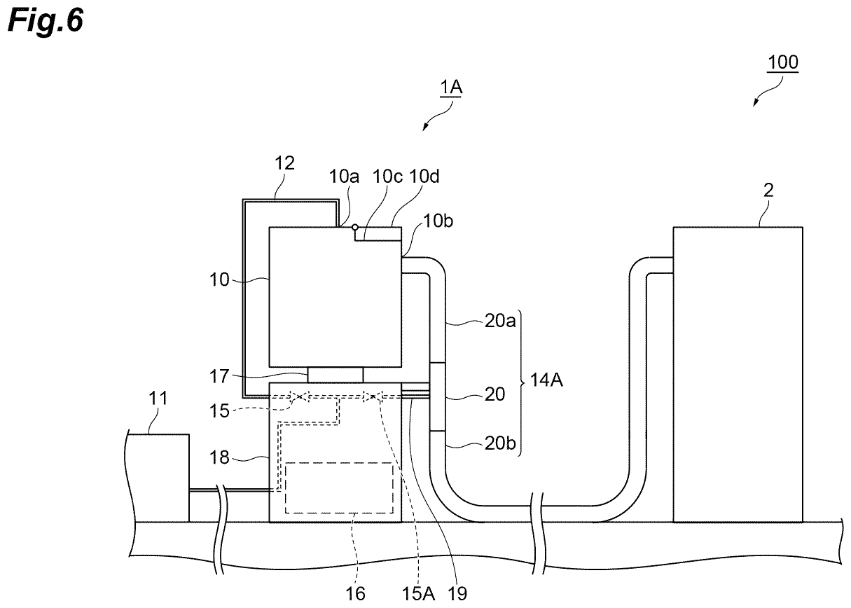

A powder feed device according to another embodiment will now be described with reference to FIGS. 6, 7, and 8. FIG. 6 is a schematic diagram illustrating an example of a dust collection system provided with a powder feed device according to another embodiment. In FIG. 6, a powder feed device is provided with a feed duct 14A instead of the feed duct 14. Below, the powder feed device 1A will be described focusing on differences from the powder feed device 1; redundant description is omitted.

The powder feed device 1A further includes a housing 18, in which the solenoid valve 15 and the control unit 16 are arranged. A load cell 17 is disposed on top of the housing 18. In the powder feed device 1A, the housing 18, the load cell 17, and the hopper 10 are arranged in that order from bottom to top.

The feed duct 14A has an ejector 20. The ejector 20 uses compressed air to generate airflow from the powder feed device 1A to the dust collector 2. In the example shown in FIG. 6, the feed duct 14A further includes a first duct 20a and a second duct 20b. The first duct 20a connects the outlet port 10b of the hopper 10 with the ejector 20, and the second duct 20b connects the ejector 20 with the dust collector 2. The ejector 20 is configured to inject a motive flow into the second duct 20b. The ejector 20 may be fixed to the housing 18.

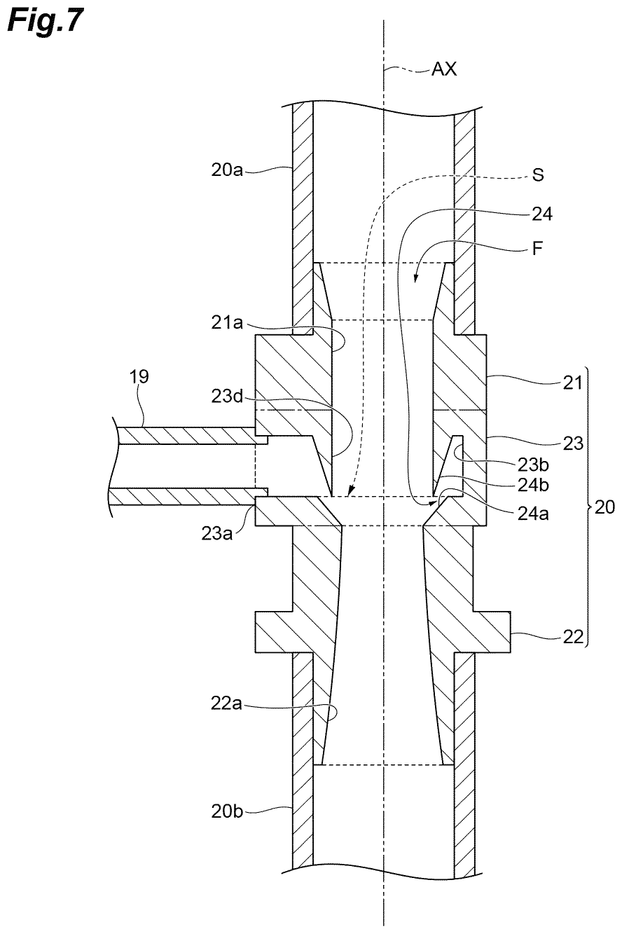

FIG. 7 is a schematic diagram showing an end face of the ejector. As shown in FIG. 7, the ejector 20 includes a suction portion 21, a feed portion 22, and an air nozzle 23. The suction portion 21 is connected to the hopper 10. For example, the suction portion 21 is connected to the hopper 10 via the first duct 20a. The feed portion 22 is configured to feed air and the powder P. For instance, the feed portion 22 is connected to the dust collector 2 via the second duct 20b and is configured to feed air and the powder P to the dust collector 2 through the second duct 20b.

The air nozzle 23 includes an opening 24 configured to inject the driving flow toward the feed portion 22. The driving flow generates negative pressure in the suction portion 21. For example, the air nozzle 23 includes an inlet 23a for compressed air, which communicates with the opening 24 of the air nozzle 23. The inlet 23a for compressed air is connected to the air source 11 via a pipe 19, so that compressed air is fed to the opening 24 of the air nozzle 23, and from the opening 24 the driving flow is injected. A solenoid valve 15A is provided in the pipe 19, and is opened and closed under the control of the control unit 16, thereby changing the supply amount and timing of the compressed air. The control unit 16 may control the amount of compressed air fed to the inlet 23a of the air nozzle 23 to be larger than the amount of compressed air fed to the inlet port 10a of the hopper 10. In this case, negative pressure is more readily generated in the suction portion 21.

According to the powder feed device 1A, a driving flow is ejected from the ejector 20 in the feed duct 14A. Due to the driving flow, the powder P that has settled in the portion of the feed duct 14A between the ejector 20 and the dust collector 2 is fed from the feed duct 14A to the dust collector 2. Consequently, the powder feed device 1A reduces the amount of powder P that remains inside the feed duct 14A, making it possible to stabilize the quantitative feed of the powder P.

In the example of FIG. 7, the suction portion 21, the air nozzle 23, and the feed portion 22 define a flow path F that extends in one direction AX. The air nozzle 23 is disposed between the suction portion 21 and the feed portion 22. Along the one direction AX, they are arranged in the order of suction portion 21, air nozzle 23, and feed portion 22. On an inner surface 23d of the air nozzle 23 that defines part of the flow path F, the opening 24 includes a slit S extending along the circumferential direction around the center of the flow path F. The compressed air fed from the inlet 23a is fed into the slit S via a groove 23b that extends in the circumferential direction around the center of the flow path F. An inner surface 21a of the suction portion 21, which defines part of the flow path F, includes a tapered surface that increases in diameter closer to the open end that draws in the powder P. An inner surface 22a of the feed portion 22, which defines part of the flow path F, similarly includes a tapered surface that increases in diameter closer to the open end that supplies the powder P. It should be noted that the configuration of the ejector is not limited to the example shown in FIG. 7: the suction portion 21 may be disposed between the air nozzle 23 and the feed portion 22, where the powder P and air might be suctioned from a direction intersecting the direction in which the driving flow travels from the air nozzle 23 to the feed portion 22.

The slit S is formed by a first tapered surface 24a and a second tapered surface 24b. The first tapered surface 24a and second tapered surface 24b are respectively inclined in directions that form a driving flow of compressed air (fed via the groove 23b) injected toward the feed portion 22. The first tapered surface 24a is adjacent to the feed portion 22, and the second tapered surface 24b faces the first tapered surface 24a in the one direction AX. In the ejector 20, the powder P flows along the one direction AX in the flow path F, thereby stabilizing the metered feed of the powder P. By means of the slit S, the driving flow is ejected around the circumference of the flow path F, making it possible to stabilize the driving flow.

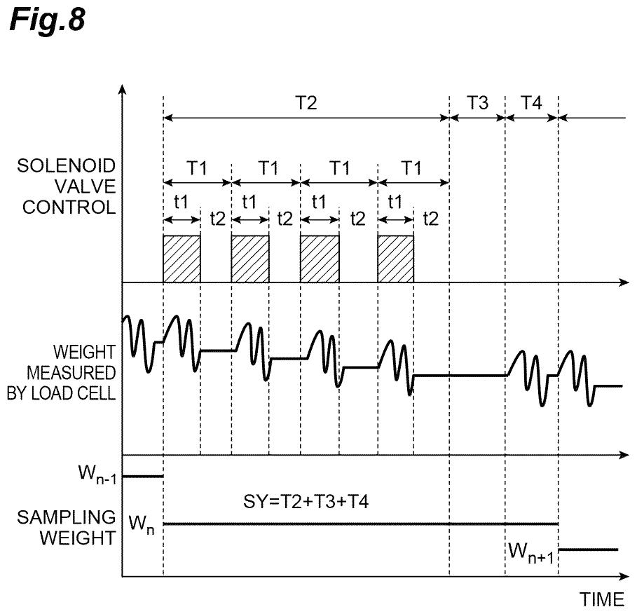

The control unit 16 may be configured so as not to inject the driving flow by the air nozzle 23 during the time the load cell 17 is measuring the weight of the hopper 10. FIG. 8 is a time chart illustrating relationships among control times of the solenoid valves 15, 15A, the weight measured by the load cell 17, and the sampling weight in the powder feed device 1A. In the example shown in FIG. 8, injection of the driving flow by the air nozzle 23 is performed at an injection cycle T4, which is the period following the computation time T3. After causing the load cell 17 to measure the weight of the hopper 10, the control unit 16 may be configured to inject the driving flow by the air nozzle 23. By controlling the driving flow injection as shown in FIG. 8, the control unit 16 can appropriately capture changes in the weight of the powder P while reducing noise from the air nozzle 23.

Referring again to FIG. 6, the configuration of the powder feed device 1A is described. The hopper 10 may have a feed port 10c and a lid 10d. The feed port 10c communicates with the interior of the hopper 10, and the lid 10d is configured to open and close the feed port 10c. For example, an operator opens the lid 10d to fill the hopper 10 with the powder P via the feed port 10c. The control unit 16 may be configured so that, when the feed port 10c is not closed by the lid 10d, the driving flow is injected from the opening 24 of the air nozzle 23. For example, the hopper 10 may further include an open/close sensor to detect whether the lid 10d is open or closed. For instance, the opening and closing of the solenoid valve 15A may be configured so that it is interlocked with the opening and closing of the lid 10d.

When the driving flow is injected from the opening 24 of the air nozzle 23, a negative pressure occurs in the suction portion 21, which causes the powder P and air to be aspirated from the outlet port 10b. Therefore, if the lid 10d is opened to fill the hopper 10 with the powder P, then the powder P and air are drawn in from the outlet port 10b, and the powder feed device 1A can thereby suppress scattering of the powder P inside the hopper 10.

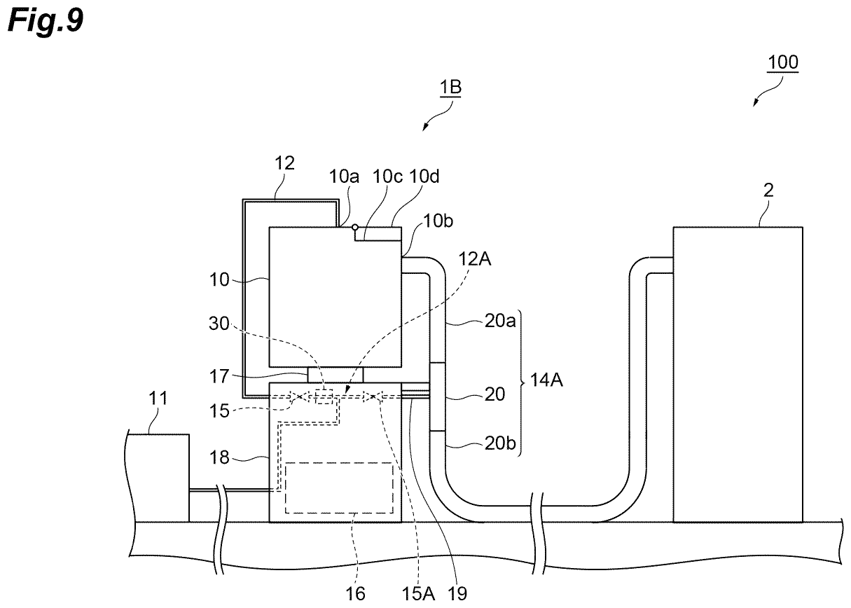

Hereinafter, a powder feed device according to yet another embodiment will be described with reference to FIG. 9. A powder feed device 1B shown in FIG. 9 further includes a pressure regulator 30 in addition to the configuration of the powder feed device 1A shown in FIG. 6. Hereinafter, the powder feed device 1B will be described focusing on the differences from the powder feed device 1A, and redundant description will be omitted.

As shown in FIG. 9, a pipe extending from the air source 11 branches into two pipes at a branch portion 12A. One pipe is the pipe 12 that supplies air to the hopper 10, and the other pipe is the pipe 19 that supplies air to the ejector 20.

The pressure regulator 30 is provided in the pipe 12. As a more specific example, the pressure regulator 30 is provided between the solenoid valve 15 provided in the pipe 12 and the branch portion 12A. The pressure regulator 30 is connected to the control unit 16 and is configured to be able to adjust the pressure of the compressed air supplied to the nozzle 13 (see FIG. 1) based on a control signal from the control unit 16.

As in the embodiments described above, when attempting to supply a minute amount of the powder P by controlling the injection time, the amount of the powder P supplied may be too large even if the injection time is made sufficiently short, and it may not be possible to achieve the target feed rate.

Therefore, the control unit 16 also controls the pressure of the air injected from the nozzle 13 (injection pressure) in addition to the injection time. For example, in the flowchart of FIG. 4, when the feed rate calculated in step S16 is greater than the target feed rate (step S18: YES), in addition to reducing the injection time (step S20), if, for example, the injection time has reached a predetermined lower limit value, the control unit 16 controls the pressure regulator 30 to reduce the pressure of the compressed air supplied to the nozzle 13.

When the pressure of the supplied air decreases, the reaction force of the injection from the nozzle 13 becomes smaller, and the movement of the nozzle 13 within the hopper 10 becomes gentler. As a result, the amount of the powder P that is stirred and becomes airborne within the hopper 10 decreases, and the amount of the powder P supplied from the supply duct 14A can be further reduced. In this way, according to the powder feed device 1B, by the control unit 16 using both the injection time and the injection pressure as control parameters, the supply amount of the powder P can be controlled with higher precision, and a constant supply can be further stabilized.

### Outline of the Embodiments of the Present Disclosure

The present disclosure includes the following aspects.

(Clause 1) A powder feed device comprising: a storage portion configured to store powder; a feed duct connected to the storage portion; a flexible nozzle disposed in the storage portion and configured to inject air into the storage portion, and configured to allow the air and the powder to be fed from the feed duct; a measuring unit configured to measure a weight of the storage portion; and a control unit configured to control an injection time of the air injected by the nozzle based on the weight measured by the measuring unit.

In this powder feed device, the powder in the storage portion becomes airborne via the flexible nozzle disposed in the storage portion, and is fed to the outside from the feed duct along with air. The weight of the storage portion is measured by the measuring unit, and the injection time of the air injected by the nozzle is controlled based on the measured weight. Because the powder feed device can control the injection time of the air in accordance with the weight of the storage portion, it can be controlled so as to feed a constant amount of powder.

(Clause 2) The powder feed device according to Clause 1, wherein the control unit may be configured to stop air injection by the nozzle while the measuring unit is measuring the weight of the storage portion. In this case, the powder feed device can appropriately measure the weight of the storage portion, without the air injection by the nozzle affecting the weight measurement of the storage portion.

(Clause 3) The powder feed device according to Clause 1 or 2, wherein the control unit may be configured to cause the measuring unit to measure the weight of the storage portion after causing the nozzle to perform an air injection process a plurality of times. In this case, even if the weight change of the storage portion per single injection is below the detection limit of the measuring unit, the powder feed device can measure the weight of the storage portion properly.

(Clause 4) The powder feed device according to any one of Clauses 1 to 3, wherein the control unit may calculate a feed rate of the powder based on the weight measured by the measuring unit, and control the injection time of the air injected by the nozzle so that the calculated feed rate approaches a preset target feed rate. In this case, the powder feed device can adjust the injection time so that the powder feed rate becomes the target feed rate.

(Clause 5) The powder feed device according to Clause 4, wherein the control unit may further control an injection pressure of the air injected by the nozzle so that the calculated feed rate approaches the target feed rate. In this case, the powder feed device can adjust the injection pressure so that the feed rate of the powder becomes the target feed rate.

(Clause 6) The powder feed device according to any one of Clauses 1 to 5, wherein the feed duct may include an ejector having a suction portion connected to the storage portion, a feed portion configured to feed the air and the powder, and an air nozzle including an opening configured to inject a driving flow toward the feed portion so as to generate a negative pressure in the suction portion. In this case, the driving flow of the ejector feeds any powder that remains in the feed duct, thereby reducing the amount of powder retained in the feed duct and stabilizing the quantitative feed of powder.

(Clause 7) The powder feed device according to Clause 6, wherein the storage portion may include a feed port in communication with an interior of the storage portion, and a lid configured to open and close the feed port, and wherein the control unit is configured to inject the driving flow from the opening of the air nozzle when the feed port is not closed by the lid. In this case, when the lid is open and the storage portion is being filled with powder, the powder and air are aspirated from the storage portion to the suction portion, so the powder feed device can suppress scattering of the powder in the storage portion.

What is claimed is:

1. A powder feed device comprising:
a storage portion configured to store powder;
a feed duct connected to the storage portion;
a flexible nozzle disposed in the storage portion, configured to inject air into the storage portion, and configured to allow the air and the powder to supplied from the feed duct;
a measuring unit configured to measure a weight of the storage portion; and
a control unit configured to control an injection time of the air injected by the nozzle based on the weight measured by the measuring unit.

2. The powder feed device according to claim 1, wherein the control unit is configured to stop air injection by the nozzle while the measuring unit is measuring the weight of the storage portion.

3. The powder feed device according to claim 1, wherein the control unit is configured to cause the measuring unit to measure the weight of the storage portion after causing the nozzle to perform an air injection process a plurality of times.

4. The powder feed device according to claim 1, wherein the control unit calculates a feed rate of the powder based on the weight measured by the measuring unit, and controls the injection time of the air injected by the nozzle so that the calculated feed rate approaches a predetermined target feed rate.

5. The powder feed device according to claim 4, wherein the control unit is further configured to control an injection pressure of the air injected by the nozzle so that the calculated feed rate approaches the target feed rate.

6. The powder feed device according to claim 1, wherein the feed duct includes an ejector, the ejector comprises:
a suction portion connected to the storage portion;
a feed portion configured to feed the air and the powder; and
an air nozzle including an opening configured to inject a driving flow toward the feed portion so as to generate a negative pressure in the suction portion.

7. The powder feed device according to claim 6, wherein the storage portion comprises:
a feed port in communication with an interior of the storage portion; and
a lid configured to open and close the feed port,
wherein the control unit is configured to inject the driving flow from the opening of the air nozzle when the feed port is not closed by the lid.
